(19) United States
(12) Patent Application Publication
(10) Pub. No.: US 2014/0047219 A1
(43) Pub. Date: Feb. 13, 2014

(54) Managing A Register Cache Based on an Architected Computer Instruction Set having Operand Last-User Information

(71) Applicant: International Business Machines Corporation, Armonk, NY (US)

(72) Inventors: Michael K. Gschwind, Chappaqua, NY (US); Valentina Salapura, Chappaqua, NY (US)

(73) Assignee: International Business Machines Corporation, Armonk, NY (US)

(21) Appl. No.: 14/057,480

(22) Filed: Oct. 18, 2013

Related U.S. Application Data
(63) Continuation of application No. 13/251,505, filed on Oct. 3, 2011.

(51) Int. Cl. G06F 9/30

(52) U.S. Cl. CPC G06F 9/3012
USPC 712/217

(57) ABSTRACT

A multi-level register hierarchy is disclosed comprising a first level pool of registers for caching registers of a second level pool of registers in a system wherein programs can dynamically release and re-enable architected registers such that released architected registers need not be maintained by the processor, the processor accessing operands from the first level pool of registers, wherein a last-use instruction is identified as having a last use of an architected register before being released, the last-use architected register being released causes the multi-level register hierarchy to discard any correspondence of an entry to said last use architected register.

### CROSS-REFERENCE TO RELATED APPLICATION

This is a Continuation application to U.S. patent Ser. No. 13/251,505 “INSTRUCTION SET HAVING OPERAND LAST-USE INFORMATION”. filed Oct. 3, 2011, which application is incorporated herein by reference.

### FIELD OF THE INVENTION

The present disclosure relates to the field of processors and, more particularly, to managing operand caches based on instruction information.

### BACKGROUND

According to Wikipedia, published Aug. 1, 2011 on the world wide web, “Multithreading Computers” have hardware support to efficiently execute multiple threads. These are distinguished from multiprocessing systems (such as multi-core systems) in that the threads have to share the resources of a single core: the computing units, the CPU caches and the translation lookaside buffer (TLB). Where multiprocessing systems include multiple complete processing units, multithreading aims to increase utilization of a single core by using thread-level as well as instruction-level parallelism. As the two techniques are complementary, they are sometimes combined in systems with multiple multithreading CPUs and in CPUs with multiple multithreading cores.

The Multithreading paradigm has become more popular as efforts to further exploit instruction level parallelism have stalled since the late-1990s. This allowed the concept of Throughput Computing to re-emerge to prominence from the more specialized field of transaction processing:

Even though it is very difficult to further speed up a single thread or single program, most computer systems are actually multi-tasking among multiple threads or programs.

Techniques that would allow speed up of the overall system throughput of all tasks would be a meaningful performance gain.

The two major techniques for throughput computing are multiprocessing and multithreading.

Some advantages include:

If a thread gets a lot of cache misses, the other thread(s) can continue, taking advantage of the unused computing resources, which thus can lead to faster overall execution, as these resources would have been idle if only a single thread was executed.

If a thread cannot use all the computing resources of the CPU (because instructions depend on each other's result), running another thread permits to not leave these idle.

If several threads work on the same set of data, they can actually share their cache, leading to better cache usage or synchronization on its values.

Some criticisms of multithreading include:

Multiple threads can interfere with each other when sharing hardware resources such as caches or translation lookaside buffers (TLBs).

Execution times of a single thread are not improved but can be degraded, even when only one thread is executing. This is due to slower frequencies and/or additional pipeline stages that are necessary to accommodate thread-switching hardware.

Hardware support for multithreading is more visible to software, thus requiring more changes to both application programs and operating systems than Multiprocessing.

Types of multithreading:

Block Multi-Threading Concept

The simplest type of multi-threading occurs when one thread runs until it is blocked by an event that normally would create a long latency stall. Such a stall might be a cache-miss that has to access off-chip memory, which might take hundreds of CPU cycles for the data to return. Instead of waiting for the stall to resolve, a threaded processor would switch execution to another thread that was ready to run. Only when the data for the previous thread had arrived, would the previous thread be placed back on the list of ready-to-run threads.

For example:

1. Cycle i: instruction j from thread A is issued

2. Cycle i+1: instruction j+1 from thread A is issued

3. Cycle i+2: instruction j+2 from thread A is issued, load instruction which misses in all caches

4. Cycle i+3: thread scheduler invoked, switches to thread B

5. Cycle i+4: instruction k from thread B is issued

6. Cycle i+5: instruction k+1 from thread B is issued

Conceptually, it is similar to cooperative multi-tasking used in real-time operating systems in which tasks voluntarily give up execution time when they need to wait upon some type of the event.

This type of multi threading is known as Block or Cooperative or Coarse-grained multithreading.

Hardware Cost

The goal of multi-threading hardware support is to allow quick switching between a blocked thread and another thread ready to run. To achieve this goal, the hardware cost is to replicate the program visible registers as well as some processor control registers (such as the program counter). Switching from one thread to another thread means the hardware switches from using one register set to another.

Such additional hardware has these benefits:

The thread switch can be done in one CPU cycle.

It appears to each thread that it is executing alone and not sharing any hardware resources with any other threads. This minimizes the amount of software changes needed within the application as well as the operating system to support multithreading.

In order to switch efficiently between active threads, each active thread needs to have its own register set. For example, to quickly switch between two threads, the register hardware needs to be instantiated twice.

### EXAMPLES

Many families of microcontrollers and embedded processors have multiple register banks to allow quick context switching for interrupts. Such schemes can be considered a type of block multithreading among the user program thread and the interrupt threads

Interleaved Multi-Threading

1. Cycle i+1: an instruction from thread B is issued

2. Cycle i+2: an instruction from thread C is issued

The purpose of this type of multithreading is to remove all data dependency stalls from the execution pipeline. Since one thread is relatively independent from other threads, there's less chance of one instruction in one pipe stage needing an output from an older instruction in the pipeline.

Conceptually, it is similar to pre-emptive multi-tasking used in operating systems. One can make the analogy that the time-slice given to each active thread is one CPU cycle.

This type of multithreading was first called Barrel processing, in which the staves of a barrel represent the pipeline stages and their executing threads. Interleaved or Pre-emptive or Fine-grained or time-sliced multithreading are more modern terminology.

Hardware Costs

In addition to the hardware costs discussed in the Block type of multithreading, interleaved multithreading has an additional cost of each pipeline stage tracking the thread ID of the instruction it is processing. Also, since there are more threads being executed concurrently in the pipeline, shared resources such as caches and TLBs need to be larger to avoid thrashing between the different threads.

Simultaneous Multi-Threading

Concept

The most advanced type of multi-threading applies to superscalar processors. A normal superscalar processor issues multiple instructions from a single thread every CPU cycle. In Simultaneous Multi-threading (SMT), the superscalar processor can issue instructions from multiple threads every CPU cycle. Recognizing that any single thread has a limited amount of instruction level parallelism, this type of multithreading tries to exploit parallelism available across multiple threads to decrease the waste associated with unused issue slots.

For example:

1. Cycle i: instructions j and j+1 from thread A; instruction k from thread B all simultaneously issued

2. Cycle i+1: instruction j+2 from thread A; instruction k+1 from thread B; instruction m from thread C all simultaneously issued

3. Cycle i+2: instruction j+3 from thread A; instructions m+1 and m+2 from thread C all simultaneously issued.

To distinguish the other types of multithreading from SMT, the term Temporal multithreading is used to denote when instructions from only one thread can be issued at a time.

Hardware Costs

In addition to the hardware costs discussed for interleaved multithreading, SMT has the additional cost of each pipeline stage tracking the Thread ID of each instruction being processed. Again, shared resources such as caches and TLBs have to be sized for the large number of active threads.

According to U.S. Pat. No. 7,827,388 “Apparatus for adjusting instruction thread priority in a multi-thread processor” issued Nov. 2, 2010, a assigned to IBM and incorporated by reference herein, a number of techniques are used to improve the speed at which data processors execute software programs. These techniques include increasing the processor clock speed, using cache memory, and using predictive branching. Increasing the processor clock speed allows a processor to perform relatively more operations in any given period of time. Cache memory is positioned in close proximity to the processor and operates at higher speeds than main memory, thus reducing the time needed for a processor to access data and instructions. Predictive branching allows a processor to execute certain instructions based on a prediction about the results of an earlier instruction, thus obviating the need to wait for the actual results and thereby improving processing speed.

Some processors also employ pipelined instruction execution to enhance system performance. In pipelined instruction execution, processing tasks are broken down into a number of pipeline steps or stages. Pipelining may increase processing speed by allowing subsequent instructions to begin processing before previously issued instructions have finished a particular process. The processor does not need to wait for one instruction to be fully processed before beginning to process the next instruction in the sequence.

Processors that employ pipelined processing may include a number of different pipeline stages which are devoted to different activities in the processor. For example, a processor may process sequential instructions in a fetch stage, decode/dispatch stage, issue stage, execution stage, finish stage, and completion stage. Each of these individual stages may employ its own set of pipeline stages to accomplish the desired processing tasks.

Multi-thread instruction processing is an additional technique that may be used in conjunction with pipelining to increase processing speed. Multi-thread instruction processing involves dividing a set of program instructions into two or more distinct groups or threads of instructions. This multi-threading technique allows instructions from one thread to be processed through a pipeline while another thread may be unable to be processed for some reason. This avoids the situation encountered in single-threaded instruction processing in which all instructions are held up while a particular instruction cannot be executed, such as, for example, in a cache miss situation where data required to execute a particular instruction is not immediately available. Data processors capable of processing multiple instruction threads are often referred to as simultaneous multithreading (SMT) processors.

It should be noted at this point that there is a distinction between the way the software community uses the term “multithreading” and the way the term “multithreading” is used in the computer architecture community. The software community uses the term “multithreading” to refer to a single task subdivided into multiple, related threads. In computer architecture, the term “multithreading” refers to threads that may be independent of each other. The term “multithreading” is used in this document in the same sense employed by the computer architecture community.

To facilitate multithreading, the instructions from the different threads are interleaved in some fashion at some point in the overall processor pipeline. There are generally two different techniques for interleaving instructions for processing in a SMT processor. One technique involves interleaving the threads based on some long latency event, such as a cache miss that produces a delay in processing one thread. In this technique all of the processor resources are devoted to a single thread until processing of that thread is delayed by some long latency event. Upon the occurrence of the long latency event, the processor quickly switches to another thread and advances that thread until some long latency event occurs for that thread or until the circumstance that stalled the other thread is resolved.

The other general technique for interleaving instructions from multiple instruction threads in a SMT processor involves interleaving instructions on a cycle-by-cycle basis according to some interleaving rule (also sometimes referred to herein as an interleave rule). A simple cycle-by-cycle interleaving technique may simply interleave instructions from the different threads on a one-to-one basis. For example, a two-thread SMT processor may take an instruction from a first thread in a first clock cycle, an instruction from a second thread in a second clock cycle, another instruction from the first thread in a third clock cycle and so forth, back and forth between the two instruction threads. A more complex cycle-by-cycle interleaving technique may involve using software instructions to assign a priority to each instruction thread and then interleaving instructions from the different threads to enforce some rule based upon the relative thread priorities. For example, if one thread in a two-thread SMT processor is assigned a higher priority than the other thread, a simple interleaving rule may require that twice as many instructions from the higher priority thread be included in the interleaved stream as compared to instructions from the lower priority thread.

A more complex cycle-by-cycle interleaving rule in current use assigns each thread a priority from “1” to “7” and places an instruction from the lower priority thread into the interleaved stream of instructions based on the function 1/(2|X−Y|+1), where X=the software assigned priority of a first thread, and Y=the software assigned priority of a second thread. In the case where two threads have equal priority, for example. X=3 and Y=3, the function produces a ratio of 1/2, and an instruction from each of the two threads will be included in the interleaved instruction stream once out of every two clock cycles. If the thread priorities differ by 2, for example, X=2 and Y=4, then the function produces a ratio of 1/8, and an instruction from the lower priority thread will be included in the interleaved instruction stream once out of every eight clock cycles.

Using a priority rule to choose how often to include instructions from particular threads is generally intended to ensure that processor resources are allotted based on the software assigned priority of each thread. There are, however, situations in which relying on purely software assigned thread priorities may not result in an optimum allotment of processor resources. In particular, software assigned thread priorities cannot take into account processor events, such as a cache miss, for example, that may affect the ability of a particular thread of instructions to advance through a processor pipeline. Thus, the occurrence of some event in the processor may completely or at least partially defeat the goal of assigning processor resources efficiently between different instruction threads in a multi-thread processor.

For example, a priority of 5 may be assigned by software to a first instruction thread in a two thread system, while a priority of 2 may be assigned by software to a second instruction thread. Using the priority rule 1/(2|X−Y|+1) described above, these software assigned priorities would dictate that an instruction from the lower priority thread would be interleaved into the interleaved instruction stream only once every sixteen clock cycles, while instructions from the higher priority instruction thread would be interleaved fifteen out of every sixteen clock cycles. If an instruction from the higher priority instruction thread experiences a cache miss, the priority rule would still dictate that fifteen out of every sixteen instructions comprise instructions from the higher priority instruction thread, even though the occurrence of the cache miss could effectively stall the execution of the respective instruction thread until the data for the instruction becomes available.

In an embodiment, each instruction thread in a SMT processor is associated with a software assigned base input processing priority. Unless some predefined event or circumstance occurs with an instruction being processed or to be processed, the base input processing priorities of the respective threads are used to determine the interleave frequency between the threads according to some instruction interleave rule. However, upon the occurrence of some predefined event or circumstance in the processor related to a particular instruction thread, the base input processing priority of one or more instruction threads is adjusted to produce one more adjusted priority values. The instruction interleave rule is then enforced according to the adjusted priority value or values together with any base input processing priority values that have not been subject to adjustment.

Intel® Hyper-threading is described in “Intel® Hyper-Threading Technology. Technical User's Guide” 2003 from Intel® corporation, incorporated herein by reference. According to the Technical User's Guide, efforts to improve system performance on single processor systems have traditionally focused on making the processor more capable. These approaches to processor design have focused on making it possible for the processor to process more instructions faster through higher clock speeds, instruction-level parallelism (ILP) and caches. Techniques to achieve higher clock speeds include pipelining the microarchitecture to finer granularities, which is also called super-pipelining. Higher clock frequencies can greatly improve performance by increasing the number of instructions that can be executed each second. But because there are far more instructions being executed in a super-pipelined microarchitecture, handling of events that disrupt the pipeline, such as cache misses, interrupts and branch mispredictions, is much more critical and failures more costly. ILP refers to techniques to increase the number of instructions executed each clock cycle. For example, many super-scalar processor implementations have multiple execution units that can process instructions simultaneously. In these super-scalar implementations, several instructions can be executed each clock cycle. With simple in-order execution, however, it is not enough to simply have multiple execution units. The challenge is to find enough instructions to execute. One technique is out-of-order execution where a large window of instructions is simultaneously evaluated and sent to execution units, based on instruction dependencies rather than program order. Accesses to system memory are slow, though faster than accessing the hard disk, but when compared to execution speeds of the processor, they are slower by orders of magnitude. One technique to reduce the delays introduced by accessing system memory (called latency) is to add fast caches close to the processor. Caches provide fast memory access to frequently accessed data or instructions. As cache speeds increase, however, so does the problem of heat dissipation and of cost. For this reason, processors often are designed with a cache hierarchy in which fast, small caches are located near and operated at access latencies close to that of the processor core. Progressively larger caches, which handle less frequently accessed data or instructions, are implemented with longer access latencies. Nonetheless, times can occur when the needed data is not in any processor cache. Handling such cache misses requires accessing system memory or the hard disk, and during these times, the processor is likely to stall while waiting for memory transactions to finish. Most techniques for improving processor performance from one generation to the next are complex and often add significant die-size and power costs. None of these techniques operate at 100 percent efficiency thanks to limited parallelism in instruction flows. As a result, doubling the number of execution units in a processor does not double the performance of the processor. Similarly, simply doubling the clock rate does not double the performance due to the number of processor cycles lost to a slower memory subsystem.

Multithreading

As processor capabilities have increased, so have demands on performance, which has increased pressure on processor resources with maximum efficiency. Noticing the time that processors wasted running single tasks while waiting for certain events to complete, software developers began wondering if the processor could be doing some other work at the same time.

To arrive at a solution, software architects began writing operating systems that supported running pieces of programs, called threads. Threads are small tasks that can run independently. Each thread gets its own time slice, so each thread represents one basic unit of processor utilization. Threads are organized into processes, which are composed of one or more threads. All threads in a process share access to the process resources.

These multithreading operating systems made it possible for one thread to run while another was waiting for something to happen. On Intel processor-based personal computers and servers, today's operating systems, such as Microsoft Windows* 2000 and Windows* XP, all support multithreading. In fact, the operating systems themselves are multithreaded. Portions of them can run while other portions are stalled.

To benefit from multithreading, programs need to possess executable sections that can run in parallel. That is, rather than being developed as a long single sequence of instructions, programs are broken into logical operating sections. In this way, if the application performs operations that run independently of each other, those operations can be broken up into threads whose execution is scheduled and controlled by the operating system. These sections can be created to do different things, such as allowing Microsoft Word* to repaginate a document while the user is typing. Repagination occurs on one thread and handling keystrokes occurs on another. On single processor systems, these threads are executed sequentially, not concurrently. The processor switches back and forth between the keystroke thread and the repagination thread quickly enough that both processes appear to occur simultaneously. This is called functionally decomposed multithreading.

Multithreaded programs can also be written to execute the same task on parallel threads. This is called data-decomposed multithreaded, where the threads differ only in the data that is processed. For example, a scene in a graphic application could be drawn so that each thread works on half of the scene. Typically, data-decomposed applications are threaded for throughput performance while functionally decomposed applications are threaded for user responsiveness or functionality concerns.

When multithreaded programs are executing on a single processor machine, some overhead is incurred when switching context between the threads. Because switching between threads costs time, it appears that running the two threads this way is less efficient than running two threads in succession. If either thread has to wait on a system device for the user, however, the ability to have the other thread continue operating compensates very quickly for all the overhead of the switching. Since one thread in the graphic application example handles user input, frequent periods when it is just waiting certainly occur. By switching between threads, operating systems that support multithreaded programs can improve performance and user responsiveness, even if they are running on a single processor system.

In the real world, large programs that use multithreading often run many more than two threads. Software such as database engines creates a new processing thread for every request for a record that is received. In this way, no single I/O operation prevents new requests from executing and bottlenecks can be avoided. On some servers, this approach can mean that thousands of threads are running concurrently on the same machine.

Multiprocessing

Multiprocessing systems have multiple processors running at the same time. Traditional Intel® architecture multiprocessing systems have anywhere from two to about 512 processors. Multiprocessing systems allow different threads to run on different processors. This capability considerably accelerates program performance. Now two threads can run more or less independently of each other without requiring thread switches to get at the resources of the processor. Multiprocessor operating systems are themselves multithreaded, and the threads can use the separate processors to the best advantage.

Originally, there were two kinds of multiprocessing: asymmetrical and symmetrical. On an asymmetrical system, one or more processors were exclusively dedicated to specific tasks, such as running the operating system. The remaining processors were available for all other tasks (generally, the user applications). It quickly became apparent that this configuration was not optimal. On some machines, the operating system processors were running at 100 percent capacity, while the user-assigned processors were doing nothing. In short order, system designers came to favor an architecture that balanced the processing load better: symmetrical multiprocessing (SMP). The “symmetry” refers to the fact that any thread—be it from the operating system or the user application—can run on any processor. In this way, the total computing load is spread evenly across all computing resources. Today, symmetrical multiprocessing systems are the norm and asymmetrical designs have nearly disappeared.

SMP systems use double the number of processors, however performance will not double. Two factors that inhibit performance from simply doubling are:
How well the workload can be parallelized
System overhead

Two factors govern the efficiency of interactions between threads:
How they compete for the same resources
How they communicate with other threads

Multiprocessor Systems

Today's server applications consist of multiple threads or processes that can be executed

in parallel. Online transaction processing and Web services have an abundance of software threads that can be executed simultaneously for faster performance. Even desktop applications are becoming increasingly parallel. Intel architects have implemented thread-level parallelism (TLP) to improve performance relative to transistor count and power consumption.

In both the high-end and mid-range server markets, multiprocessors have been commonly used to get more performance from the system. By adding more processors, applications potentially get substantial performance improvement by executing multiple threads on multiple processors at the same time. These threads might be from the same application, from different applications running simultaneously, from operating-system services, or from operating-system threads doing background maintenance. Multiprocessor systems have been used for many years, and programmers are familiar with the techniques to exploit multiprocessors for higher performance levels.

US Patent Application Publication No. 2011/0087865 “Intermediate Register Mapper” filed Apr. 14, 2011 by Barrick et al., and incorporated herein by reference teaches “A method, processor, and computer program product employing an intermediate register mapper within a register renaming mechanism. A logical register lookup determines whether a hit to a logical register associated with the dispatched instruction has occurred. In this regard, the logical register lookup searches within at least one register mapper from a group of register mappers, including an architected register mapper, a unified main mapper, and an intermediate register mapper. A single hit to the logical register is selected among the group of register mappers. If an instruction having a mapper entry in the unified main mapper has finished but has not completed, the mapping contents of the register mapper entry in the unified main mapper are moved to the intermediate register mapper, and the unified register mapper entry is released, thus increasing a number of unified main mapper entries available for reuse.”

U.S. Pat. No. 6,314,511 filed Apr. 2, 1998 “Mechanism for freeing registers on processors that perform dynamic out-of-order execution of instructions using renaming registers” by Levy et al., incorporated by reference herein teaches “freeing renaming registers that have been allocated to architectural registers prior to another instruction redefining the architectural register. Renaming registers are used by a processor to dynamically execute instructions out-of-order in either a single or multi-threaded processor that executes instructions out-of-order. A mechanism is described for freeing renaming registers that consists of a set of instructions, used by a compiler, to indicate to the processor when it can free the physical (renaming) register that is allocated to a particular architectural register. This mechanism permits the renaming register to be reassigned or reallocated to store another value as soon as the renaming register is no longer needed for allocation to the architectural register. There are at least three ways to enable the processor with an instruction that identifies the renaming register to be freed from allocation: (1) a user may explicitly provide the instruction to the processor that refers to a particular renaming register; (2) an operating system may provide the instruction when a thread is idle that refers to a set of registers associated with the thread; and (3) a compiler may include the instruction with the plurality of instructions presented to the processor. There are at least five embodiments of the instruction provided to the processor for freeing renaming registers allocated to architectural registers: (1) Free Register Bit; (2) Free Register; (3) Free Mask; (4) Free Opcode; and (5) Free Opcode/Mask. The Free Register Bit instruction provides the largest speedup for an out-of-order processor and the Free Register instruction provides the smallest speedup.”

“Power ISA™ Version 2.06 Revision B” published Jul. 23, 2010 from IBM® and incorporated by reference herein teaches an example RISC (reduced instruction set computer) instruction set architecture. The Power ISA will be used herein in order to demonstrate example embodiments, however, the invention is not limited to Power ISA or RISC architectures. Those skilled in the art will readily appreciate use of the invention in a variety of architectures.

“z/Architecture Principles of Operation” SA22-7832-08, Ninth Edition (August, 2010) from IBM® and incorporated by reference herein teaches an example CISC (complex instruction set computer) instruction set architecture.

### SUMMARY

A multi-level register hierarchy is employed including a first level pool of registers and at least one higher level pool of registers. The first level pool of registers is a high speed cache of registers to be quickly accessed by execution elements of the processor, while the higher level pool of registers maintains all assigned registers, preferably a complete set of architected registers of an instruction set architecture (ISA), for each thread running on the processor and all rename registers of the processor, whereby architected registers and/or rename registers can be dynamically assigned to the multi-level register hierarchy.

Last-use instructions are executed, wherein a last-use instruction is enabled to use an architected register for the last-time. Subsequent to executing the last-use instruction, the architected register identified as a last-use architected register is no longer a valid entry in the multi-level register hierarchy.

Advantageously, the first level pool of registers is enabled to hold more useful architected registers by reducing the number of active architected registers, particularly in a multi-threaded, out-of-order execution environment.

In an embodiment, a multi-level register hierarchy is managed, comprising a first level pool of registers for caching registers of a second level pool of registers. A processor assigns architected registers to available entries of one of said first level pool or said second level pool, wherein architected registers are defined by an ISA and addressable by register field values of instructions of the ISA, wherein the assigning comprises associating each assigned architected register to a corresponding an entry of a pool of registers. Architected register values are moved to said first level pool from said second level pool according to a first level pool replacement algorithm. Based on instructions being executed, architected register values of the first level pool of registers corresponding to said architected registers are accessed. executing a last-use instruction for using an architected register identified as a last-use architected register, the last-use architected register is un-assigned from both the first level pool and the second level pool, wherein un-assigned entries are available for assigning to architected registers.

In an embodiment, based on determining the last-use instruction is to be executed, the last-use instruction including a register field value identifying the last-use architected register to be un-assigned after execution of the last-use instruction, the value of the last-use architected register is copied to a second level physical register of the second level pool of registers. Then, the last-use instruction is executed. The un-assigning of the physical register is performed after last-use of the value of the architected register according to the last-use instruction. Then, a physical register is un-assigned, of the second level pool of registers, as the architected register based on the last-use instruction being executed being committed to complete.

In an embodiment, decoding the last-use instruction for execution, it is determined that the last-use architected register is to be un-assigned after execution of the last-use instruction.

In an embodiment, the un-assigning the physical register is determined by instruction completion logic of the processor.

In an embodiment, the multi-level register hierarchy holds recently accessed architected registers in the first level pool and infrequently accessed architected registers in the second level pool.

In an embodiment, the architected registers comprise any one of general registers or floating point registers, wherein architected instructions comprise opcode fields and register fields, the register fields configured to identify a register of the architected registers.

In an embodiment, a last-use identifying instruction is executed, the execution comprising identifying an architected register of the last-use instruction as the last-use architected register.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an example processor system configuration;

FIG. 2 depicts a first example processor pipeline;

FIG. 3 depicts a second example processor pipeline;

FIG. 4 depicts an example embodiment; and

FIGS. 5-8 depict example flow diagrams.

### DETAILED DESCRIPTION

An Out of Order (OoO) processor typically contains multiple execution pipelines that may opportunistically execute instructions in a different order than what the program sequence (or “program order”) specifies in order to maximize the average instruction per cycle rate by reducing data dependencies and maximizing utilization of the execution pipelines allocated for various instruction types. Results of instruction execution are typically held temporarily in the physical registers of one or more register files of limited depth. An OoO processor typically employs register renaming to avoid unnecessary serialization of instructions due to the reuse of a given architected register by subsequent instructions in the program order.

According to Barrick, under register renaming operations, each architected (i.e. logical) register targeted by an instruction is mapped to a unique physical register in a register file. In current high-performance OoO processors, a unified main mapper is utilized to manage the physical registers within multiple register files. In addition to storing the logical-to-physical register translation (i.e., in mapper entries), the unified main mapper is also responsible for storing dependency data (i.e. queue position data), which is important for instruction ordering upon completion.

In a unified main mapper-based renaming scheme, it is desirable to free mapper entries as soon as possible for reuse by the OoO processor. However, in the prior art, a unified main mapper entry cannot be freed until the instruction that writes to a register mapped by the mapper entry is completed. This constraint is enforced because, until completion, there is a possibility that an instruction that has “finished” (i.e., the particular execution unit (EU) has successfully executed the instruction) will still be flushed before the instruction can “complete” and before the architected, coherent state of the registers is updated.

In current implementations, resource constraints at the unified main mapper have generally been addressed by increasing the number of unified main mapper entries. However, increasing the size of the unified main mapper has a concomitant penalty in terms of die area, complexity, power consumption, and access time.

In Barrick, there is provided a method for administering a set of one or more physical registers in a data processing system. The data processing system has a processor that processes instructions out-of-order, wherein the instructions reference logical registers and wherein each of the logical registers is mapped to the set of one or more physical registers. In response to dispatch of one or more of the instructions, a register management unit performs a logical register lookup, which determines whether a hit to a logical register associated with the dispatched instruction has occurred within one or more register mappers. In this regard, the logical register lookup searches within at least one register mapper from a group of register mappers, including an architected register mapper, a unified main mapper, and an intermediate register mapper. The register management unit selects a single hit to the logical register among the group of register mappers. If an instruction having a mapper entry in the unified main mapper has finished but has not completed, the register management unit moves logical-to-physical register renaming data of the unified main mapping entry in the unified main mapper to the intermediate register mapper, and the unified main mapper releases the unified main mapping entry prior to completion of the instruction. The release of the unified main mapping entry increases a number of unified main mapping entries available for reuse.

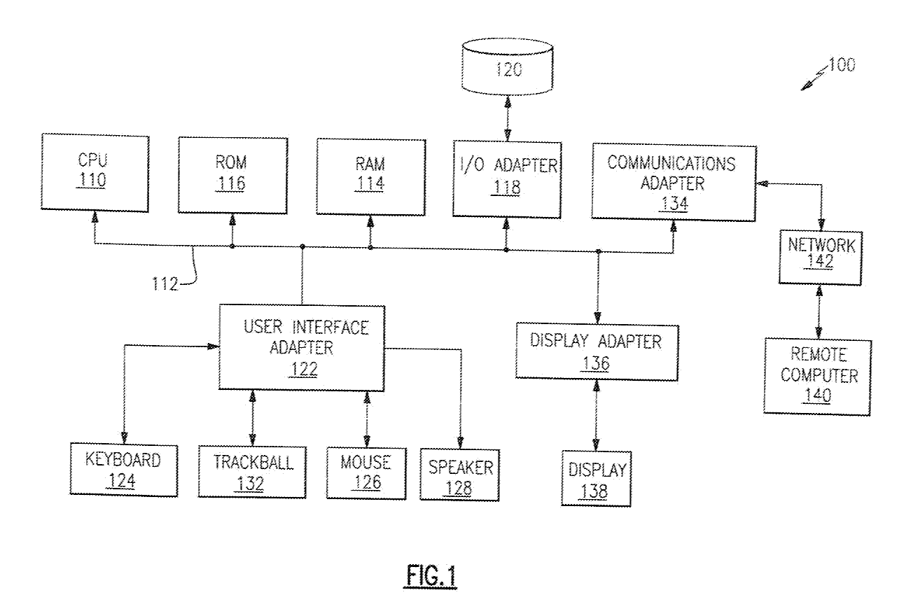

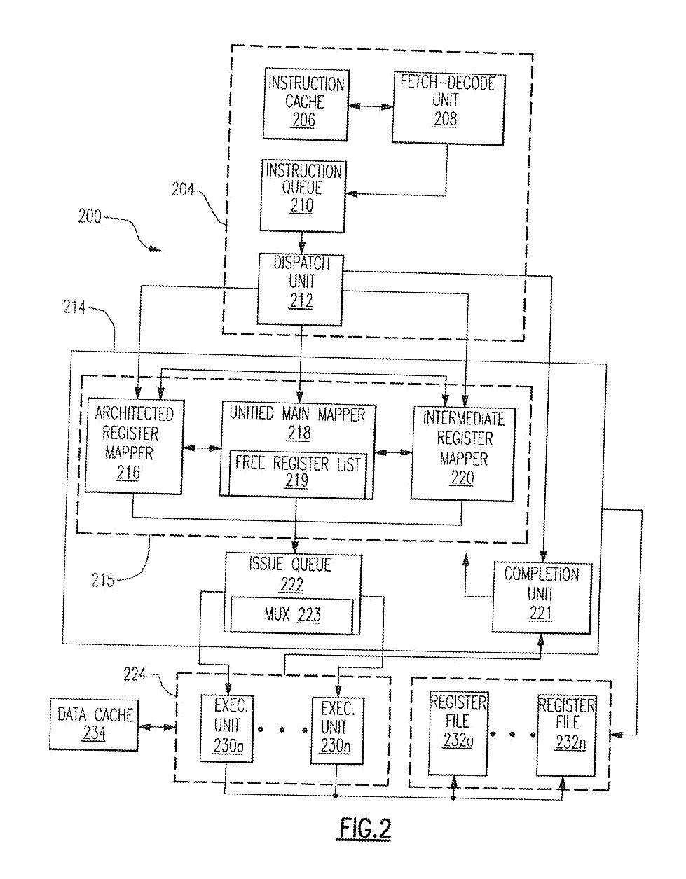

With reference now to the figures, and in particular to FIG. 1, an example is shown of a data processing system 100 which may include an OoO processor employing an intermediate register mapper as described below with reference to FIG. 2. As shown in FIG. 1, data processing system 100 has a central processing unit (CPU) 110, which may be implemented with processor 200 of FIG. 2. CPU 110 is coupled to various other components by an interconnect 112. Read only memory (“ROM”) 116 is coupled to the interconnect 112 and includes a basic input/output system (“BIOS”) that controls certain basic functions of the data processing system 100. Random access memory (“RAM”) 114, I/O adapter 118, and communications adapter 134 are also coupled to the system bus 112. I/O adapter 118 may be a small computer system interface (“SCSI”) adapter that communicates with a storage device 120. Communications adapter 134 interfaces interconnect 112 with network 140, which enables data processing system 100 to communicate with other such systems, such as remote computer 142. Input/Output devices are also connected to interconnect 112 via user interface adapter 122 and display adapter 136. Keyboard 124, track ball 132, mouse 126 and speaker 128 are all interconnected to bus 112 via user interface adapter 122. Display 138 is connected to system bus 112 by display adapter 136. In this manner, data processing system 100 receives input, for example, throughout keyboard 124, trackball 132, and/or mouse 126 and provides output, for example, via network 142, on storage device 120, speaker 128 and/or display 138. The hardware elements depicted in data processing system 100 are not intended to be exhaustive, but rather represent principal components of a data processing system in one embodiment.

Operation of data processing system 100 can be controlled by program code, such as firmware and/or software, which typically includes, for example, an operating system such as AIX® (“AIX” is a trademark of the IBM Corporation) and one or more application or middleware programs.

Referring now to FIG. 2, there is depicted a superscalar processor 200. Instructions are retrieved from memory (e.g., RAM 114 of FIG. 1) and loaded into instruction sequencing logic (ISL) 204, which includes Level 1 Instruction cache (L1 I-cache) 206, fetch-decode unit 208, instruction queue 210 and dispatch unit 212. Specifically, the instructions are loaded in L1 I-cache 206 of ISL 204. The instructions are retained in L1 I-cache 206 until they are required, or replaced if they are not needed. Instructions are retrieved from L1 I-cache 206 and decoded by fetch-decode unit 208. After decoding a current instruction, the current instruction is loaded into instruction queue 210. Dispatch unit 212 dispatches instructions from instruction queue 210 into register management unit 214, as well as completion unit 240. Completion unit 240 is coupled to general execution unit 224 and register management unit 214, and monitors when an issued instruction has completed.

When dispatch unit 212 dispatches a current instruction, unified main mapper 218 of register management unit 214 allocates and maps a destination logical register number to a physical register within physical register files 232a-232n that is not currently assigned to a logical register. The destination is said to be renamed to the designated physical register among physical register files 232a-232n. Unified main mapper 218 removes the assigned physical register from a list 219 of free physical registers stored within unified main mapper 218. All subsequent references to that destination logical register will point to the same physical register until fetch-decode unit 208 decodes another instruction that writes to the same logical register. Then, unified main mapper 218 renames the logical register to a different physical location selected from free list 219, and the mapper is updated to enter the new logical-to-physical register mapper data. When the logical-to-physical register mapper data is no longer needed, the physical registers of old mappings are returned to free list 219. If free physical register list 219 does not have enough physical registers, dispatch unit 212 suspends instruction dispatch until the needed physical registers become available.

After the register management unit 214 has mapped the current instruction, issue queue 222 issues the current instruction to general execution engine 224, which includes execution units (EUs) 230a-230n. Execution units 230a-230n are of various types, such as floating-point (FP), fixed-point (FX), and load/store (LS). General execution engine 224 exchanges data with data memory (e.g. RAM 114, ROM 116 of FIG. 1) via a data cache 234. Moreover, issue queue 222 may contain instructions of FP type, FX type, and LS instructions. However, it should be appreciated that any number and types of instructions can be used. During execution, EUs 230a-230n obtain the source operand values from physical locations in register file 232a-232n and store result data, if any, in register files 232a-232n and/or data cache 234.

Still referring to FIG. 2, register management unit 214 includes: (i) mapper cluster 215, which includes architected register mapper 216, unified main mapper 218, intermediate register mapper 220, and (ii) issue queue 222. Mapper cluster 215 tracks the physical registers assigned to the logical registers of various instructions. In an exemplary embodiment, architected register mapper 216 has 16 logical (i.e., not physically mapped) registers of each type that store the last, valid (i.e. checkpointed) state of logical-to-physical register mapper data. However, it should be recognized that different processor architectures can have more or less logical registers, as described in the exemplary embodiment. Architected register mapper 216 includes a pointer list that identifies a physical register which describes the checkpointed state. Physical register files 232a-232n will typically contain more registers than the number of entries in architected register mapper 216. It should be noted that the particular number of physical and logical registers that are used in a renaming mapping scheme can vary.

In contrast, unified main mapper 218 is typically larger (typically contains up to 20 entries) than architected register mapper 216. Unified main mapper 218 facilitates tracking of the transient state of logical-to-physical register mappings. The term “transient” refers to the fact that unified main mapper 218 keeps track of tentative logical-to-physical register mapping data as the instructions are executed out-of-order. OoO execution typically occurs when there are older instructions which would take longer (i.e., make use of more clock cycles) to execute than newer instructions in the pipeline. However, should an OoO instruction's executed result require that it be flushed for a particular reason (e.g. a branch miss-prediction), the processor can revert to the checkpointed state maintained by architected register mapper 216 and resume execution from the last, valid state.

Unified main mapper 218 makes the association between physical registers in physical register files 232a-232n and architected register mapper 216. The qualifying term “unified” refers to the fact that unified main mapper 218 obviates the complexity of custom-designing a dedicated mapper for each of register files 232 (e.g. general-purpose registers (GPRs), floating-point registers (FPRs), fixed-point registers (FXPs), exception registers (XERs), condition registers (CRs), etc.).

In addition to creating a transient, logical-to-physical register mapper entry of an OoO instruction, unified main mapper 218 also keeps track of dependency data (i.e., instructions that are dependent upon the finishing of an older instruction in the pipeline), which is important for instruction ordering. Conventionally, once unified main mapper 218 has entered an instruction's logical-to-physical register translation, the instruction passes to issue queue 222. Issue queue 222 serves as the gatekeeper before the instruction is issued to execution unit 230 for execution. As a general rule, an instruction cannot leave issue queue 222 if it depends upon an older instruction to finish. For this reason, unified main mapper 218 tracks dependency data by storing the issue queue position data for each instruction that is mapped. Once the instruction has been executed by general execution engine 224, the instruction is said to have “finished” and is retired from issue queue 222.

Register management unit 214 may receive multiple instructions from dispatch unit 212 in a single cycle so as to maintain a filled, single issue pipeline. The dispatching of instructions is limited by the number of available entries in unified main mapper 218. In conventional mapper systems, which lack intermediate register mapper 220, if unified main mapper 218 has a total of 20 mapper entries, there is a maximum of 20 instructions that can be in flight (i.e., not checkpointed) at once. Thus, dispatch unit 212 of a conventional mapper system can conceivably “dispatch” more instructions than what can actually be retired from unified main mapper 218. The reason for this bottleneck at the unified main mapper 218 is due to the fact that, conventionally, an instruction's mapper entry could not retire from unified main mapper 218 until the instruction “completed” (i.e., all older instructions have “finished” executing).

According to one embodiment, intermediate register mapper 220 serves as a non-timing-critical register for which a “finished”, but “incomplete” instruction from unified main mapper 218 could retire to (i.e., removed from unified main mapper 218) in advance of the instruction's eventual completion. Once the instruction “completes”, completion unit 240 notifies intermediate register mapper 220 of the completion. The mapper entry in intermediate register mapper 220 can then update the architected coherent state of architected register mapper 216 by replacing the corresponding entry that was presently stored in architected register mapper 216.

When dispatch unit 212 dispatches an instruction, register management unit 214 evaluates the logical register number(s) associated with the instruction against mappings in architected register mapper 216, unified main mapper 218, and intermediate register mapper 220 to determine whether a match (commonly referred to as a “hit”) is present in architected register mapper 216, unified main mapper 218, and/or intermediate register mapper 220. This evaluation is referred to as a logical register lookup. When the lookup is performed simultaneously at more than one register mapper (i.e., architected register mapper 216, unified main mapper 218, and/or intermediate register mapper 220), the lookup is referred to as a parallel logical register lookup.

Each instruction that updates the value of a certain target logical register is allocated a new physical register. Whenever this new instance of the logical register is used as a source by any other instruction, the same physical register must be used. As there may exist a multitude of instances of one logical register, there may also exist a multitude of physical registers corresponding to the logical register. Register management unit 214 performs the tasks of (i) analyzing which physical register corresponds to a logical register used by a certain instruction, (ii) replacing the reference to the logical register with a reference to the appropriate physical register (i.e., register renaming), and (iii) allocating a new physical register whenever a new instance of any logical register is created (i.e., physical register allocation).

Initially, before any instructions are dispatched, the unified main mapper 218 will not receive a hit/match since there are no instructions currently in flight. In such an event, unified main mapper 218 creates a mapping entry. As subsequent instructions are dispatched, if a logical register match for the same logical register number is found in both architected register mapper 216 and unified main mapper 218, priority is given to selecting the logical-to-physical register mapping of unified main mapper 218 since the possibility exists that there may be instructions currently executing OoO (i.e., the mapping is in a transient state).

After unified main mapper 218 finds a hit/match within its mapper, the instruction passes to issue queue 222 to await issuance for execution by one of execution units 230. After general execution engine 224 executes and “finishes” the instruction, but before the instruction “completes”, register management unit 214 retires the mapping entry presently found in unified main mapper 218 from unified main mapper 218 and moves the mapping entry to intermediate register mapper 220. As a result, a slot in unified main mapper 218 is made available for mapping a subsequently dispatched instruction. Unlike unified main mapper 218, intermediate register mapper 220 does not store dependency data. Thus, the mapping that is transferred to intermediate register mapper 220 does not depend (and does not track) the queue positions of the instructions associated with its source mappings. This is because issue queue 222 retires the “finished, but not completed” instruction is after a successful execution. In contrast, under conventional rename mapping schemes lacking an intermediate register mapper, a unified main mapper continues to store the source rename entry until the instruction completes. Under the present embodiment, intermediate register mapper 220 can be positioned further away from other critical path elements because, unified main mapper 218, its operation is not timing critical.

Once unified main mapper 218 retires a mapping entry from unified main mapper 218 and moves to intermediate register mapper 220, mapper cluster 214 performs a parallel logical register lookup on a subsequently dispatched instruction to determine if the subsequent instruction contains a hit/match in any of architected register mapper 216, unified main mapper 218, and intermediate register mapper 220. If a hit/match to the same destination logical register number is found in at least two of architected register mapper 216, unified main mapper 218, and intermediate register mapper 220, multiplexer 223 in issue queue 222 awards priority by selecting the logical-to-physical register mapping of unified main mapper 218 over that of the intermediate register mapper 220, which in turn, has selection priority over architected register mapper 216.

The mechanism suggested by Barrick by which the selection priority is determined is discussed as follows. A high level logical flowchart of an exemplary method of determining which mapping data values to use in executing an instruction, in accordance with one embodiment. In an embodiment, a dispatch unit 212 dispatching one or more instructions to register management unit 214. In response to the dispatching of the instruction(s), register management unit 214 determines via a parallel logical register lookup whether a “hit” to a logical register (in addition to a “hit” to architected register mapper 216) associated with each dispatched instruction has occurred. In this regard, it should be understood that architected register mapper 216 is assumed to always have hit/match, since architected register mapper 216 stores the checkpointed state of the logical-to-physical register mapper data. If register management unit 214 does not detect a match/hit in unified main mapper 218 and/or intermediate register mapper 220, multiplexer 223 selects the logical-to-physical register renaming data from architected register mapper 216. If register management unit 214 detects a match/hit in unified main mapper 218 and/or intermediate register mapper 220, register management unit 214 determines in a decision block whether a match/hit occurs in both unified main mapper 218 and intermediate register mapper 220. If a hit/match is determined in both mappers 218 and 220, a register management unit 214 determines whether the mapping entry in unified main mapper 218 is “younger” (i.e., the creation of the mapping entry is more recent) than the mapping entry in intermediate register mapper 220. If entry in unified main mapper 218 is younger than the entry in intermediate register mapper 220, multiplexer 223 selects the logical-to-physical register renaming data from unified main mapper 218. If the entry in unified main mapper 218 is not younger than the entry in intermediate register mapper 220, multiplexer 223 selects the logical-to-physical register renaming data from intermediate register mapper 220.

If a match/hit does not occur in both unified main mapper 218 and intermediate register mapper 220, it is determined whether an exclusive hit/match to unified main mapper 218 occurs. If an exclusive hit to unified main mapper 218 occurs, multiplexer 223 selects the logical-to-physical register renaming data from unified main mapper 218. However, if a hit/match does not occur at unified main mapper 218 (thus, the hit/match exclusively occurs at intermediate register mapper 220), multiplexer 223 selects the logical-to-physical register renaming data from intermediate register mapper 220 (block 320). A general execution engine 224 uses the output data of the logical register lookup for execution.

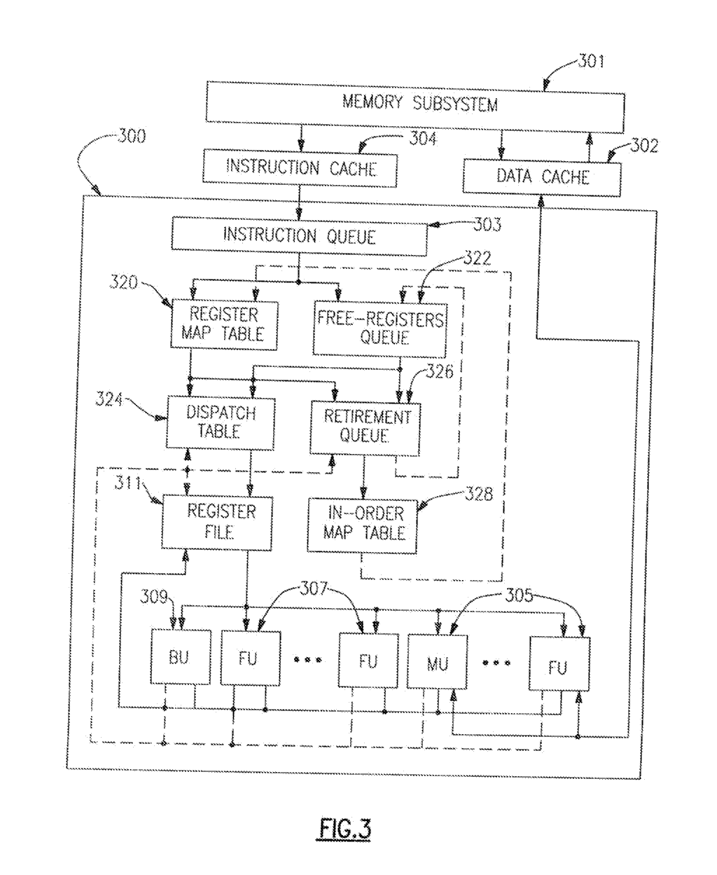

In an example embodiment a dispatch unit 212 dispatches one or more instructions to register management unit 214. A unified main mapper creates a new, logical-to-physical register mapping entry. Issue queue 222 maintains the issue queue position data of the dispatched instruction, which utilizes the mapping entry that is selected via the logical register lookup (described in FIG. 3). General execution engine 224 detects whether any of the instructions under execution has finished (i.e., one of Us 130 has finished execution of an instruction). If the issued instruction has not finished, the method waits for an instruction to finish. In response to general execution engine 224 detecting that an instruction is finished, unified main mapper 218 moves the logical-to-physical register renaming data from unified main mapper 218 to intermediate register mapper 220. Unified main mapper 218 retires the unified main mapping entry associated with the finished instruction. A completion unit 240 determines whether the finished instruction has completed. If the finished instruction has not completed, completion unit 240 continues to wait until it detects that general execution unit 224 has finished all older instructions. However, if completion unit 240 detects that the finished instruction has completed, intermediate register mapper 220 updates the architected coherent state of architected register mapper 216 and the intermediate register mapper 220 retires its mapping entry.

U.S. Pat. No. 6,189,088 “Forwarding stored data fetched for out-of-order load/read operation to over-taken operation read-accessing same memory location” to Gschwind, filed Feb. 13, 2001 and incorporated herein by reference describes an example out-of-order (OoO) processor.

According to Gschwind, FIG. 3 is a functional block diagram of a conventional computer processing system (e.g. including a superscalar processor) that supports dynamic reordering of memory operations and hardware-based implementations of the interference test and data bypass sequence. That is, the system of FIG. 3 includes the hardware resources necessary to support reordering of instructions using the mechanisms listed above, but does not include the hardware resources necessary to support the execution of out-of-order load operations before in-order load operations. The system consists of: a memory subsystem 301; a data cache 302; an instruction cache 304; and a processor unit 300. The processor unit 500 includes: an instruction queue 303; several memory units (MUs) 305 for performing load and store operations; several functional units (FUs) 307 for performing integer, logic and floating-point operations; a branch unit (BU) 309; a register file 311; a register map table 320; a free-registers queue 322; a dispatch table 324; a retirement queue 326; and an in-order map table 328.

In the processor depicted in FIG. 3, instructions are fetched from instruction cache 304 (or from memory subsystem 301, when the instructions are not in instruction cache 304) under the control of branch unit 309, placed in instruction queue 303, and subsequently dispatched from instruction queue 303. The register names used by the instructions for specifying operands are renamed according to the contents of register map table 320, which specifies the current mapping from architected register names to physical registers. The architected register names used by the instructions for specifying the destinations for the results are assigned physical registers extracted from free-registers queue 322, which contains the names of physical registers not currently being used by the processor. The register map table 320 is updated with the assignments of physical registers to the architected destination register names specified by the instructions. Instructions with all their registers renamed are placed in dispatch table 324. Instructions are also placed in retirement queue 326, in program order, including their addresses, and their physical and architected register names. Instructions are dispatched from dispatch table 324 when all the resources to be used by such instructions are available (physical registers have been assigned the expected operands, and functional units are free). The operands used by the instruction are read from register file 311, which typically includes general-purpose registers (GPRs), floating-point registers (FPRs), and condition registers (CRs). Instructions are executed, potentially out-of-order, in a corresponding memory unit 305, functional unit 307 or branch unit 309. Upon completion of execution, the results from the instructions are placed in register file 311. Instructions in dispatch table 324 waiting for the physical registers set by the instructions completing execution are notified. The retirement queue 326 is notified of the instructions completing execution, including whether they raised any exceptions. Completed instructions are removed from retirement queue 326, in program order (from the head of the queue). At retirement time, if no exceptions were raised by an instruction, then in-order map table 328 is updated so that architected register names point to the physical registers in register file 311 containing the results from the instruction being retired; the previous register names from in-order map table 328 are returned to free-registers queue 322.

On the other hand, if an instruction has raised an exception, then program control is set to the address of the instruction being retired from retirement queue 326. Moreover, retirement queue 326 is cleared (flushed), thus canceling all unretired instructions. Further, the register map table 320 is set to the contents of in-order map table 328, and any register not in in-order map table 328 is added to free-registers queue 322.

A conventional superscalar processor that supports reordering of load instructions with respect to preceding load instructions (as shown in FIG. 3) may be augmented with the following:

1. A mechanism for marking load instructions which are issued out-of-order with respect to preceding load instructions;
2. A mechanism to number instructions as they are fetched, and determine whether an instruction occurred earlier or later in the instruction stream. An alternative mechanism may be substituted to determine whether an instruction occurred earlier or later with respect to another instruction;
3. A mechanism to store information about load operations which have been executed out-of-order, including their address in the program order, the address of their access, and the datum value read for the largest guaranteed atomic unit containing the loaded datum;
4. A mechanism for performing an interference test when a load instruction is executed in-order with respect to one or more out-of-order load instructions, and for performing priority encoding when multiple instructions interfere with a load operation;
5. A mechanism for bypassing the datum associated with an interfering load operation; and
6. A mechanism for deleting the record generated in step (3) at the point where the out-of-order state is retired from retirement queue 326 to register file 311 in program order.

The mechanisms disclosed by Gschwind are used in conjunction with the mechanisms available in the conventional out-of-order processor depicted in FIG. 3, as follows. Each instruction is numbered with an instruction number as it enters instruction queue 303. A load instruction may be dispatched from dispatch table 324 earlier than a preceding load instruction. Such a load instruction is denoted below as an ‘out-of-order’ load operation. In such a case, the entry in retirement queue 326 corresponding to the load instruction is marked as an out-of-order load.

The detection of the dispatching of an out-of-order load operation from dispatch table 324 to a memory unit 305 for execution is preferably accomplished with two counters, a “loads-fetched counter” and a “loads-dispatched counter”. The loads-fetched counter is incremented when a load operation is added to dispatch table 324. The loads-dispatched counter is incremented when a load operation is sent to a memory unit 305 for execution. The current contents of the loads-fetched counter is attached to a load instruction when the load instruction is added to dispatch table 324. When the load instruction is dispatched from dispatch table 324 to a memory unit 305 for execution, if the value attached to the load instruction in dispatch table 324 is different from the contents of the loads-dispatched counter at that time, then the load instruction is identified as an out-of-order load operation. Note that the difference among the two counter values corresponds to the exact number of load operations with respect to which load instruction is being issued out-of-order. Out-of-order load instructions are only dispatched to a memory unit 305 if space for adding entries in load-order table is available.

The load-order table is a single table which is accessed by all memory units 305 simultaneously (i.e., only a single logical copy is maintained, although multiple physical copies may be maintained to speed up processing). Note that if multiple physical copies are used, then the logical contents of the multiple copies must always reflect the same state to all memory units 305.

The instruction number of the instruction being executed and the fact of whether an instruction is executed speculatively is communicated to memory unit 305 for each load operation issued.

An instruction set architecture (ISA), implemented by a processor, typically defines a fixed number of architected general purpose registers that are accessible, based on register fields of instructions of the ISA. In out-of-order execution processors, rename registers are assigned to hold register results of speculatively executed of instructions. The value of the rename register is committed as an architected register value, when the corresponding speculative instruction execution is “committed” or “completed. Thus, at any one point in time, and as observed by a program executing on the processor, in a register rename embodiment, there exist many more rename registers than architected registers.

In one embodiment of rename registers, separate registers are assigned to architected registers and rename registers. In another, embodiment, rename registers and architected registers are merged registers. The merged registers include a tag for indicating the state of the merged register, wherein in one state, the merged register is a rename register and in another state, the merged register is an architected register.

In a merged register embodiment, as part of the initialization (for example, during a context switch, or when initializing a partition), the first n physical registers are assigned as the architectural registers, where n is the number of the registers declared by the instruction set architecture (ISA). These registers are set to be in the architectural register (AR) state; the remaining physical registers take on the available state. When an issued instruction includes a destination register, a new rename buffer is needed. For this reason, one physical register is selected from the pool of the available registers and allocated to the destination register. Accordingly, the selected register state is set to the rename buffer not-valid state (NV), and its valid bit is reset. After the associated instruction finishes execution, the produced result is written into the selected register, its valid bit is set, and its state changes to rename buffer (RB), valid. Later, when the associated instruction completes, the allocated rename buffer will be declared to be the architectural register that implements the destination register specified in the just completed instruction. Its state then changes to the architectural register state (AR) to reflect this.

While registers are almost a universal solution to performance, they do have a drawback. Different parts of a computer program all use their own temporary values, and therefore compete for the use of the registers. Since a good understanding of the nature of program flow at runtime is very difficult, there is no easy way for the developer to know in advance how many registers they should use, and how many to leave aside for other parts of the program. In general these sorts of considerations are ignored, and the developers, and more likely, the compilers they use, attempt to use all the registers visible to them. In the case of processors with very few registers to begin with, this is also the only reasonable course of action.

Register windows aim to solve this issue. Since every part of a program wants registers for its own use, several sets of registers are provided for the different parts of the program. If these registers were visible, there would be more registers to compete over, i.e. they have to be made invisible.

Rendering the registers invisible can be implemented efficiently; the CPU recognizes the movement from one part of the program to another during a procedure call. It is accomplished by one of a small number of instructions (prologue) and ends with one of a similarly small set (epilogue). In the Berkeley design, these calls would cause a new set of registers to be “swapped in” at that point, or marked as “dead” (or “reusable”) when the call ends.

Processors such as PowerPC save state to predefined and reserved machine registers. When an exception happens while the processor is already using the contents of the current window to process another exception, the processor will generate a double fault in this very situation.

In an example RISC embodiment, only eight registers out of a total of 64 are visible to the programs. The complete set of registers are known as the register file, and any particular set of eight as a window. The file allows up to eight procedure calls to have their own register sets. As long as the program does not call down chains longer than eight calls deep, the registers never have to be spilled, i.e. saved out to main memory or cache which is a slow process compared to register access. For many programs a chain of six is as deep as the program will go.

By comparison, another architecture provides simultaneous visibility into four sets of eight registers each. Three sets of eight registers each are “windowed”. Eight registers (i0 through i7) form the input registers to the current procedure level. Eight registers (L0 through L7) are local to the current procedure level, and eight registers (o0 through o7) are the outputs from the current procedure level to the next level called. When a procedure is called, the register window shifts by sixteen registers, hiding the old input registers and old local registers and making the old output registers the new input registers. The common registers (old output registers and new input registers) are used for parameter passing. Finally, eight registers (g0 through g7) are globally visible to all procedure levels.

An improved the design allocates the windows to be of variable size, which helps utilization in the common case where fewer than eight registers are needed for a call. It also separated the registers into a global set of 64, and an additional 128 for the windows.

Register windows also provide an easy upgrade path. Since the additional registers are invisible to the programs, additional windows can be added at any time. For instance, the use of object-oriented programming often results in a greater number of “smaller” calls, which can be accommodated by increasing the windows from eight to sixteen for instance. The end result is fewer slow register window spill and fill operations because the register windows overflow less often.

Instruction set architecture (ISA) processor out-of-order instruction implementations may execute architected instructions directly or by use of firmware invoked by a hardware instruction decode unit. However, many processors “crack” architected instructions into micro-ops directed to hardware units within the processor. Furthermore, a complex instruction set computer (CISC) architecture processor, may translate CISC instructions into reduced instruction set computer (RISC) architecture instructions. In order to teach aspects of the invention, ISA machine instructions are described, and internal operations (iops) may be deployed internally as the ISA machine instruction, or as smaller units (micro-ops), or microcode or by any means well known in the art, and will still be referred to herein as machine instructions. Machine instructions of an ISA have a format and function as defined by the ISA, once the ISA machine instruction is fetched and decoded, it may be transformed into iops for use within the processor.

An instruction set architecture (ISA) provides instruction formats wherein the value of the operand is explicitly or implicitly available to the instruction being executed by a processor. Operands may be, for example, provided by an “immediate” field of an instruction, by a register explicitly identified by a register field value of the instruction or implicitly defined for the OpCode value of the instruction. Furthermore an Operand may be located in main storage and addressed by a register value of a register defined by an instruction. The address of the operand in main storage may also be determined by adding the immediate field of the instruction to a value of a base register, or by adding a value of a base register to a value of an index register, or by adding a value of a base register to a value of an index register and a value of an immediate filed.

In order to provide fast access to operands and to support parallel execution, operand caching is employed. For example, an operand in main storage may be cached in a storage cache of a hierarchy of storage caches, where caches provide coherency by providing exclusive use of a line for example to a processor that needs to perform a store to the operand. It is important that the cache closest to the processor be fast, which means that cache is likely to be small. As a result, values of the cache are stored-thru the cache, cast-out, returned to a higher level cache or otherwise evicted frequently to make room for new operands needed by the processor.

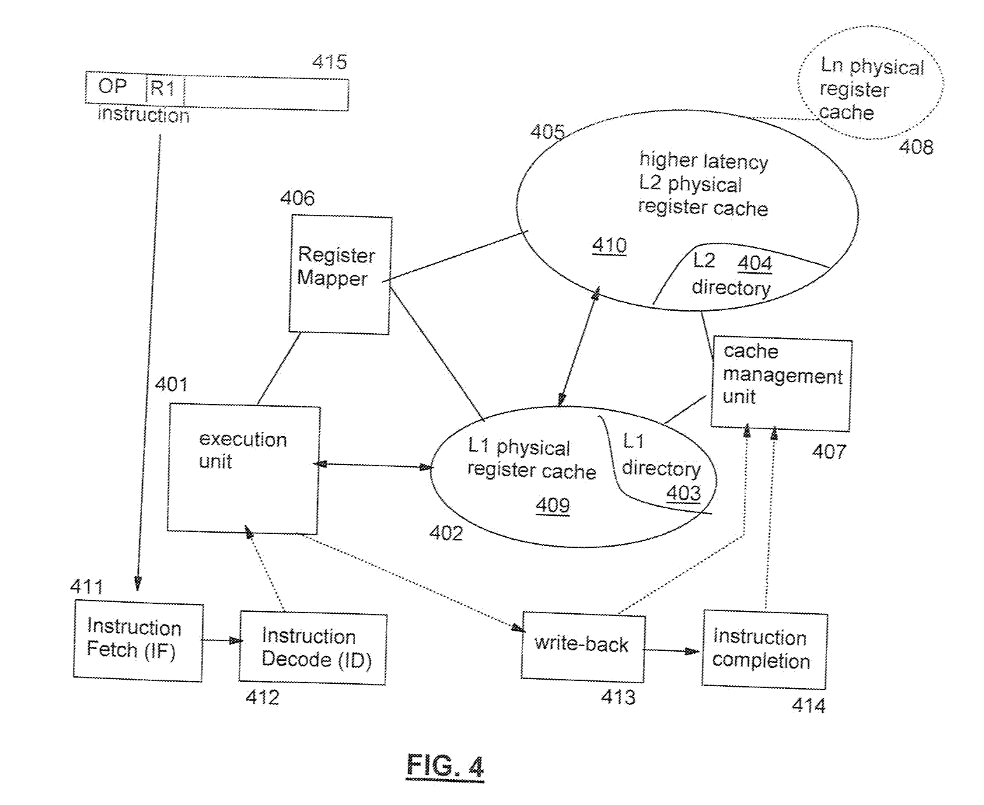

Referring to FIG. 4, an example Multi-level register set hierarchy (register cache) structure is shown. A register mapper 406 assigns architected registers to physical registers. The physical registers are a pool of available registers and assigned registers. The lowest level cache (L1 402) is a small, low latency cache and the highest level cache (Ln 408) is the largest high latency cache. In an embodiment, the highest level cache (L2 405 in a 2 level cache) is inclusive, in that it holds a copy of any register currently defined. In another embodiment, each cache of the hierarchy holds a unique register, not found in other caches. Since cache implementations are well known, a two level cache consisting of L1 402 and L2 405 will be used herein for explanation.

When a context of a program is loaded, the register mapper assigns physical registers (of the pool of physical registers of the cache hierarchy) to architected registers according to the ISA. In an example, 64 registers are assigned by the mapper to physical registers in the L2 register cache 405. A L2 directory 404 is created, mapping architected registers to corresponding entry locations 410 in the L2 register cache 405. Initial values of architected registers are loaded into the data entries 410.

When a first instruction is executed, the execution unit 401 requests access to an architected register in the L1 register cache 402. The L1 directory 403 determines that the architected register is not in the L1 cache 402 so requests the architected register from the L2 cache directory 404 using a cache management unit 407. The L2 directory locates the entry in the L2 cache and sends it to the L1 register cache 402. The L1 register cache 402 permits access to the entry 409 using the L1 directory 403 to locate the entry.

In an embodiment, the cache management unit 407 manages the L1 cache 402 using, for example, a least-recently-used (LRU) replacement algorithm, but maintains a current copy in the L2 cache 405 for the full set of registers and a current copy of a sub-set in the L1 cache 402. In an embodiment, a copy of L1 cache 402 entries are written back to the L2 cache 405 when instructions complete that modify the L1 cache 402 entry. The embodiment shown in FIG. 4 is illustrative of only one possible embodiment. Other embodiments are possible, for example, an L1 cache implemented in a content addressable memory (CAM) having entries comprising directory fields and a corresponding data field with an L2 cache implemented in a random access memory (RAM), wherein the L1 cache directory field comprises an address of an L2 entry corresponding to the L1 entry for example.

In an embodiment, the L1 and L2 directory entries include some or all of a valid bit, a register address field, an LRU indicator field, a sequence field and a thread field. The valid bit indicates whether the directory entry is valid, the register address field indicates the register address that is assigned to the entry, the LRU indicator field for indicating how recently the entry has been used, the sequence field indicating the relative age of the corresponding rename register (wherein an age of 0 indicates the entry holds the current architecture value corresponding to the most recently completed instruction), and the thread field indicating with which thread the register is associated. In an embodiment, 2 threads can be active at a time, and the thread field would be implemented by a single bit. In the embodiment, 2 sets of 64 architected GPRs (one for each of the two threads) and a larger number of rename registers would be held in the L2 cache 405. Of course some of these fields (including the LRU) are not needed by the inclusive L2 cache 405. However, only those most-recently-used would be resident in the L1 cache 402 at any one time.

Multi-level register set hierarchies (register caches hierarchies) provide architects with the ability to design processors that support large numbers of threads (e.g. 8 or more threads) and large register files for each thread (e.g., 64 architected general registers and an even larger number of temporary rename registers). In order for multi-level register files to work efficiently, frequently used values must be maintained in lower latency cache levels, and unused values should be maintained in a level of the hierarchy with a longer latency to allow the most frequently used values to be stored in low latency register file levels (register cache). The decision on placing register files would depend exclusively on the past access patterns to a register, without being able to exploit data flow knowledge available in the compiler to place registers in the appropriate level. For example, a least recently used (LRU) or a first in, first out (FIFO) replacement algorithm might be used.

In an embodiment, a multi-level register file hierarchy exploits information, provided by the compiler, about future access in a register file. For example, the processor executes an instruction set wherein certain “last-use instructions” (LU instructions) include last-use information. In one embodiment, when a last-use indication is detected for a register, the register is pushed to a higher (longer latency) register file hierarchy level from the lower latency cache. In accordance with one embodiment, a writeback of an operand to the slower storage is initiated when an operand is fetched. In another embodiment, a writeback of the operand is initiated when the instruction indicating last-use is completed. In yet another embodiment, when a last-use indication is detected for an architected register, the associated architected register is de-allocated (no longer assigned to an architected register) and the value is discarded (not pushed to a next level). This is preferably performed when the instruction which used the register the last time is completed. However, variations of determining when last-use of the register will occur based on the teaching are also contemplated, including specifying a number of times the register will be accessed, specifying a number of instructions to be executed, specifying a specific instruction etc.

In an embodiment, a multi-level register file (a.k.a. register cache) is managed by exploiting last-use information in an instruction set. When a last-use of a register is indicated, the specified register is deleted from at least one multi-level register file level. Last-use may be indicated by a semantic specification of setting the last-used value to an undefined value. In an embodiment, when a last-use is indicated, the specified register is deleted from all levels of the multi-level register file.

In an embodiment, a multi-level register file includes register file placement logic wherein the placement logic determines a level in the hierarchy to place a specific register file. In the embodiment, a last-use indication is received from instruction decode logic of the processor decoding an instruction containing last-use indication and instruction completion information from instruction completion logic, wherein last-use information is provided by an instruction specifying that a last-use has occurred or, wherein last-use information corresponds to a multi-level register file hint instruction.

Preferably, the instruction providing the last-use indication is a prefix instruction to the instruction actually using the register for the last time, however, an instruction that specifies its own last-use of a register is another embodiment contemplated herein. It is also possible that an instruction may specify last-use for a plurality of architected general purpose registers (GPRs). In another embodiment, an instruction specifies a last-use for registers of the instruction as well as last-use of registers of another (later) instruction.

In an example, architected GP registers may be assigned to multiple physical registers of a pool of physical registers in order to support out-of-order (OoO) execution of instructions, where the values of result operands are assigned to temporary registers (rename registers) prior to completion of execution of the instruction and to the current architected general registers when the associated instruction is completed. The assignment of values to a physical register may include a tag that indicates whether the corresponding physical register has an allegiance to an architected register having a final value or whether the corresponding physical register has an allegiance to an architected register having an interim value having an association to an architected register or whether the corresponding physical register is not currently assigned any association with an architected register.

Similarly to main storage caching, the pool of physical registers may constitute a cache hierarchy of physical registers, wherein some physical registers are provided in a small, fast access array which is a register cache of a larger, slower access array. For example the cached physical registers (register cache) may be implemented in latch circuits, a small random access array or a small content addressable array. The register cache having a data portion and a directory (tag) portion, the data portion holding operand values associated with a register, the directory portion identifying the architected register or rename register associated with the data portion. In such an implementation, architected registers are cached in active physical registers when they are frequently or currently being used, but are moved to the slower array to make room for more recent accessed registers, for example.

A large pool of physical registers is particularly useful in a multi-threaded environment, where multiple ISA threads are executed at a time by the same processor. In a processor ISA having 64 architected general purpose registers performing out of order execution, the processor must provide the 64 architected GPRs as well as a large number of rename registers for temporarily holding intermediate GPR state. In such a processor supporting multi-threading, each thread supported by the processor needs these registers. In an 8 threaded processor of the ISA, 512 registers are needed just for the architected GPRs, not to mention a larger number of rename registers.

In an embodiment, the multi-threaded processor employs a register cache mechanism, wherein the directory of the register cache preferably includes a thread identifier for identifying the thread association with the register. The directory preferably includes an architecture register identifier for identifying with which architected register of the string the corresponding register operand is associated. The directory preferably includes a completion indicator, indicating which register value is committed by a completion of a corresponding instruction.

The problem with caches in general is the overhead in managing data. A register value that is not cached will be slower to access, and the cache access will be impacted by cast-outs and updates. The present invention provides a way for the processor to know whether an architected register value needs to be retained or not. In an embodiment programmer providing the instructions being executed, is provided instructions for managing the existence of selected GPRs. Thus, although the instruction set architecture (ISA) provides 64 architected GPRs for each thread, the programmer can selectively enable or disable them. In an embodiment, a programmer is limited to use of 32 of the 64 GPRs. The program module to be run on the thread is compiled to disable 32 GPRs and only use the other 32 registers. In an environment, the program is compiled to generate two equivalent modules, one using 64 GPRs, the other using 32 GP registers. The module executed is selected by the operating system (OS) for example, based on environmental considerations (such as power or performance status). The selective enablement of GP registers, enables the underlying processor to provide a higher hit ratio in the register cache, since there are fewer total GPRs being supported at any one time for example.

In another embodiment, the programmer is not able to enable/disable GPRs, but is provided a way to indicate “liveness” information to the processor. Thus, for example, the programmer can inform the processor that the value of a register is a temporary value that will not be used again, and therefore, need not be saved. The processor can base the register cache operation accordingly, by, for example, not storing the value in the cache at all, or in another example, removing the GP register from the cache without writing back to the slow array.

In one embodiment, a last-use (LU) instruction comprises an OpCode field specifying function to be performed and a register field specifying a LU register. When the LU instruction is executed, the operand in the LU register is read from the first level register file (L1RF) and used to perform the function. Once the LU register has been read, the processor knows from the LU instruction, that the operand in the LU register is no longer needed. The processor can perform a variety of actions based on the knowledge, including discarding the value from the cache, removing allegence of the physical register to any architected register, moving allegence of the architected register to an entry in a slower cache for example.

In an embodiment the LU register is any one of a general register, a floating point register, an adjunct register (such as access registers of the z/Architecture ISA) or a generic register useful for either scaler or floating point values.

In an embodiment any read access to an LU register by a later instruction wherein no intervening instruction has written to the LU register, will return an ISA specified machine specific value (default value), wherein the machine specific value is any one of unpredictable, undefined or a predetermined value, wherein the predetermined value may be all 1's all 0's, an incremented value, a decremented value, a value set by a programmable register or a combination of these values.

The register cache hierarchy could consist of any number of levels, however, in order to teach the invention, the disclosure primarily discusses a single level cache. The teaching of the single level cache can be used by one skilled in the art to practice aspects of the invention in multi-level register cache implementations, within the scope of the present invention.

Referring to FIG. 4, in an example implementation, an Instruction Fetch (IF) 411 unit fetches instructions 415 from main storage, an Instruction Decode (ID) 412 unit decodes the instruction and based on the ID decode, architected registers not already in the lower Level 1 register file (L1RF) 402 are loaded from the higher level (level n) register file (LnRF) 405 while less active architected registers are moved from L1 RF 402 to LnRF 405 according to the L1 replacement algorithm. Next, the instruction is executed in an execution (EX) unit 401 and any resulting operand value is written back (WB) 413 to the L1 RF 402. When the instruction completes, a completion unit 414 (Complete) assigns the written-back operand to be the current architected register.

In an embodiment, a multi-level register file (i.e., register caching using LnRFs) offers a way to maintain low latency register access (to L1 cache 402), while providing a large register file. A First level (lowest level) register file provides fast access, most recently accessed values. A Second level (higher level) register file provides slower access, and a complete set of registers for each thread.

### Multi-Level Cache Management:

A Goal is to hold most frequently used registers in cache (L1 RF) since those registers are more likely to be accessed again. However, without insight from the programmer, it is difficult to predict what registers will actually be used in the future.

A history-based approach (least recently used (LRU) or first-in-first-out (FIFO) replacement) may be used, however, history-based register files are particularly inefficient for small register file cache levels.

A Multi-level register file with ISA providing last-use information is presented. The multi-level register file, in an embodiment has a traditional replacement algorithm (LRU or FIFO) which is augmented based on last-use (LU) information about architected registers.

When a last-use (LU) indication is provided by an instruction, operand cache management actions are performed on an operand specified as a LU operand of the instruction comprising one or more of:

The management action pushing an operand value to a higher level cache (LnRF) and deleting it from the lower level cache (L1RF). The management action may be performed when the instruction completes, when the instruction last accesses the operand or initiating the push when the LU indication is detected, and deleting from the lower level cache (L1 RF) at a later time;

The management action pushing a LU operand value to a higher level cache (LnRF) and marking the operand for deletion in the lower level cache (L1 RF); and

The management action deleting all copies of the operand at all levels of cache upon completion.

Advantageously, pushing a data item to a higher level cache will enable:

Higher reliability by using a level of memory which can be protected either with more protection mechanisms (error correction code (ecc), raid redundancy etc), or more area and power efficient protection mechanisms, or both, because it is not in the critical path of execution; and

Higher performance by ensuring that unused values are displaced to make room in lower level cache levels; and

Better power/energy characteristics

Those skilled in the art will understand that when the last-user accessed the LU value (as indicated by an LU instruction), under normal execution no further reads are to be expected. However, due to exceptions and other special conditions, instruction execution may be aborted, and instruction may be re-executed. Thus, delaying pushing a value to the next higher level retains value in current level until no further event can cause a need to reread the value. However, since these events are infrequent, in one embodiment, the value is pushed to the higher level after the last read, and if an exceptional condition occurs, the value can be retrieved from higher level.

In an embodiment, the operand is deleted from the cache without a writeback when the instruction completes.

In an embodiment, the operand is deleted from the cache when the instruction having the last-use (LU) and specifying the operand to be undefined completes. The operand is not pushed to a higher level cache (LnRF) and future referenced to the operand location will either return an ISA defined default value including, for example an old value, a predetermined value (all 1's or all 0's for example) or undefined value.

In another embodiment, the operand is deleted when it is known that no further exceptions can occur which might cause a need to re-read the value. For example, when it has been determined that no instruction pending completion up to and including the LU instruction can encounter an exception.

In an embodiment, the operand is deleted from all levels of the cache hierarchy (L1RF-LnRF) when the LU instruction completes, without writing the result back and future references to the operand location will either return an old value, a predetermined value (all 1's or all 0's for example) or undefined value.

In an embodiment, the operand is deleted from all levels of the cache hierarchy (L1 RF-LnRF) when it is determined that no exceptions can occur which might cause a need to re-read the operand, where it has been determined that no instruction pending completion up to and including the LU instruction indicating last-use and specifying the setting to an undefined value, can experience an exception.

In an embodiment, the operand is pushed to a higher level cache when it is an LU operand, then the operand is deleted from the current level cache when the operand has been read for execution. Next, the LU operand is deleted from one or all of the cache levels. In an embodiment, if a writeback of the operand is pending after deletion, the writeback is canceled.

In an embodiment, a writeback is initiated to a next higher level cache when the last-use operand is first detected, then the operand is deleted from the lower level cache when the operand has been read. Finally, the operand is deleted from one or all levels of the cache. In an embodiment, if the writeback is still pending, the writeback is canceled.

Advantageously, eliminating unused values from the multi-level register file will enable the following:

Higher reliability eliminating unused values from the register file which can experience an integrity error, forcing correction or termination of execution at the application, partition and/or system level. With respect to error correction, integrity errors must either be corrected at significant power and/or performance. When errors cannot be corrected, a system outage at the application, partition and/or system level will occur, when the affected application, partition and/or system is terminated due a data integrity condition;

Higher performance by making available more entries for used values at the plurality of cache levels; and

Better power/energy characteristics because unused portions of a register file may be de-energized.

In an example embodiment, an instruction having a last-use indication indicating an operand value of a register will not be used by any later instruction is executed. A copy of the operand is first copied to a higher level cache, in case an event occurs (such as an exception condition) that causes the instruction execution to be aborted, wherein the copy will be available for later execution. This copy may be deleted along with the lower level cache value when the instruction execution completes (is committed). The instruction is decoded. Then, operands to be used in execution are read. Next, writeback of the last-use (LU) operand identified to be last-used by this instruction is initiated to the higher level register file (LnRF). Next, the instruction is executed including an access to the LU operand. Finally, the LU operand is deleted from the short latency register file (L1RF)

In an embodiment, an instruction having a last-use indication, does not save an operand value of a register, but deletes all instances of the operand at all levels of the cache (register file) hierarchy when completed. In an embodiment, the invalid bit is reset in the directories 403 404 corresponding to the operand register. In an other embodiment, a separate allocate/deallocate bit is used.

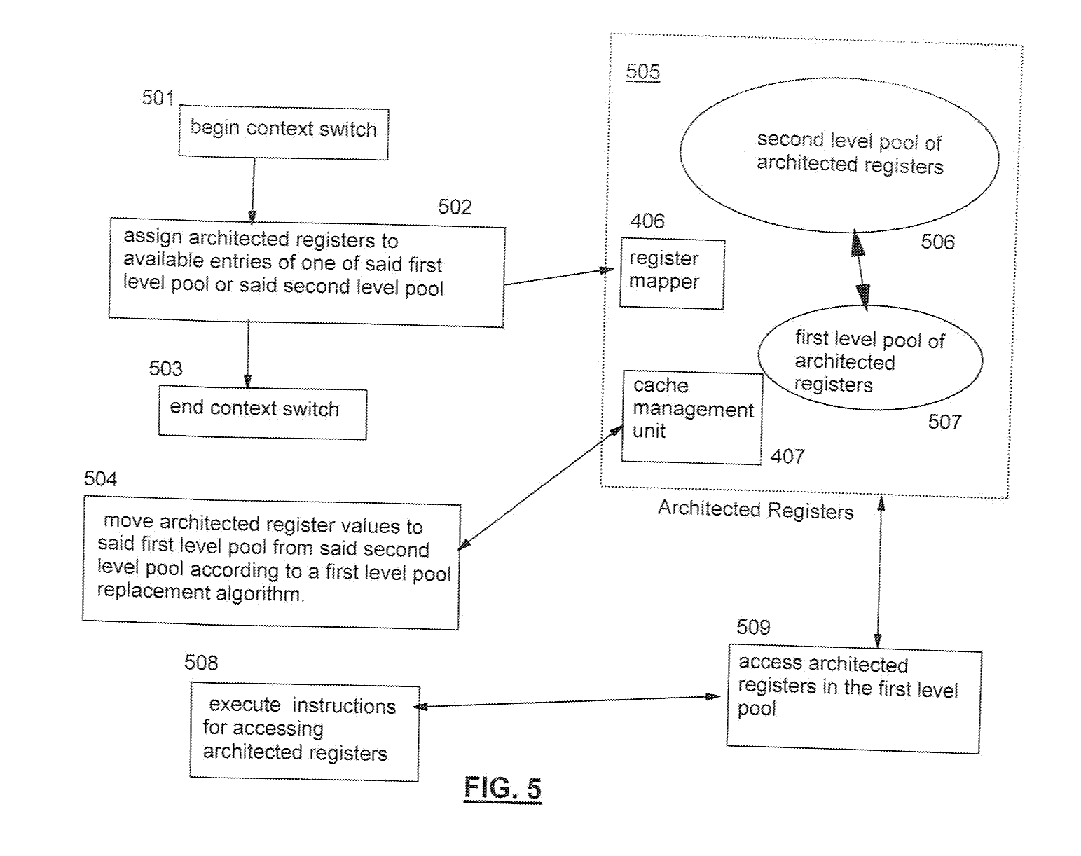

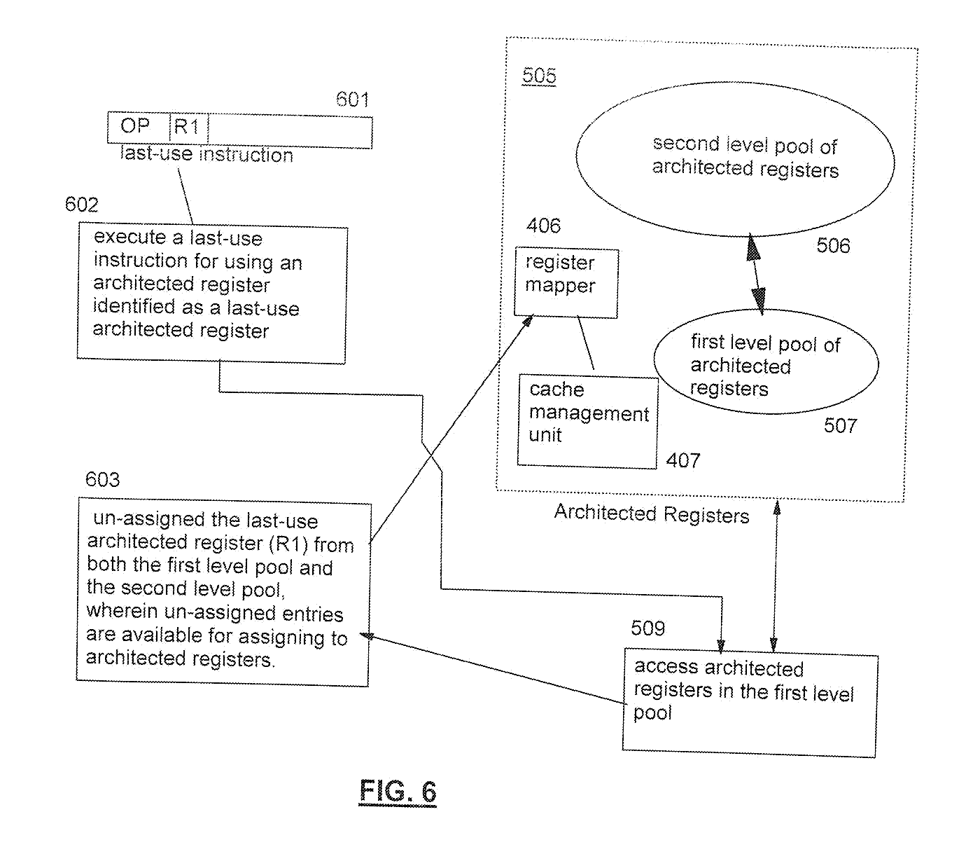

Referring to FIG. 5, in an embodiment, a multi-level register hierarchy is managed, having architected registers 505 mapped to register pools, the multi-level register hierarchy comprising a first level pool 507 of registers for caching registers of a second level pool 506 of registers. At an initialization such as after beginning a context switch operation 501, a processor assigns 502 architected registers to available entries of one of said first level pool or said second level pool, wherein architected registers are defined by an instruction set architecture (ISA) and addressable by register field values of instructions of the ISA, wherein the assigning comprises associating each assigned architected register to a corresponding an entry of a pool of registers. Then after initialization (context switching) is done 503, architected register values are moved 504 to said first level pool 507 from said second level pool 505 according to a first level pool replacement algorithm by a cache management unit 407. Based on instructions being executed 508, architected register values of the first level pool 507 of registers corresponding to said architected registers are accessed 509. Referring to FIG. 6, executing 602 a last-use instruction 601 for using 509 an architected register identified as a last-use architected register, the last-use architected register is un-assigned 603 from both the first level pool 507 and the second level pool 506 by a register mapper 406, wherein un-assigned entries are available for assigning to architected registers.

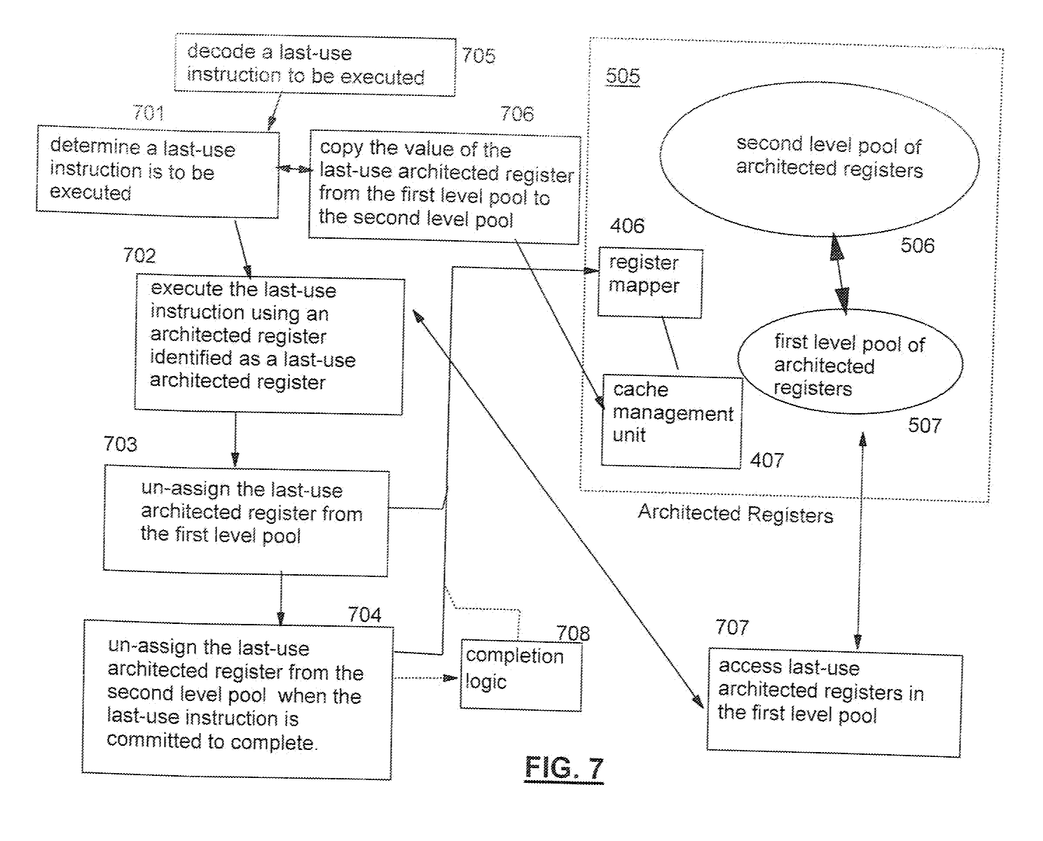

Referring to FIG. 7, in an embodiment, based on determining 701 the last-use instruction 601 is to be executed, the last-use instruction including a register field value identifying the last-use architected register to be un-assigned after execution of the last-use instruction, the value of the last-use architected register is copied 706 from the first level pool 507 to a second level entry of the second level pool 506 of registers. Then, the last-use instruction is executed 702. The un-assigning 703 of the architected register from the first pool 507 is performed after last-use of the value of the architected register according to the last-use instruction. Then, the architected register of the second level pool 506 of registers is un-assigned 704 based on the last-use instruction being executed being committed to complete.

In an embodiment, decoding 705 the last-use instruction for execution, it is determined that the last-use architected register is to be un-assigned after execution of the last-use instruction.

In an embodiment, the un-assigning the architected register 603 is determined by instruction completion logic 708 of the processor.

In an embodiment, the multi-level register hierarchy 505 holds recently accessed architected registers in the first level pool 507 and infrequently accessed architected registers in the second level pool 506.

In an embodiment, the architected registers comprise any one of general registers or floating point registers, wherein architected instructions comprise opcode fields and register fields, the register fields configured to identify a register of the architected registers.

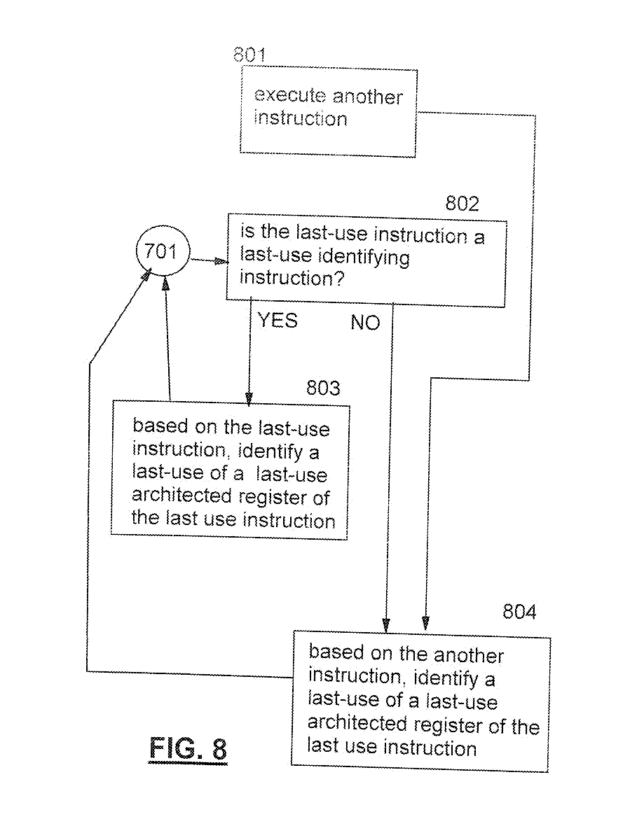

Referring to FIG. 8, in an embodiment, another instruction is a last-use identifying instruction, wherein the another instruction is executed 801, the execution comprising, based on the another instruction, identifying 804 an architected register of the last-use instruction as the last-use architected register instead of identifying the last-use instruction 803 based on the last-use instruction being the lsat-use identifying instruction.

Preferably, an indication of which architected registers are enabled or not enabled is saved to a save area for a program (X) being interrupted, and an indication of which architected registers are enabled or not enabled is obtained from the save area for new program (Y) is fetched during a context switch, wherein the save area may be implemented as an architected register location or a main storage location available to an operating system (OS). The indication may be a bit significant field where each bit corresponds to an architected register entry, or a range, or otherwise indicating the enabled/active architected registers. In an embodiment, only a subset, determined by the OS, may be enabled. In an embodiment each thread of a multi-threaded processor has its own set of enabled, disabled indicators. In another embodiment, the value of active indicators of an active program or thread can be explicitly set by machine instructions available to the active program or thread.

In an embodiment, an access to a disable architected register causes a program exception to be indicated.

In an embodiment, a disabled architected register is enabled by execution of a register enabling instruction that does not write to the disabled architected register.

In a commercial implementation of functions and instructions, such as operating system programmers writing in assembler language. These instruction formats stored in a storage medium 114 (also known as main storage or main memory) may be executed natively in a z/Architecture IBM Server. PowerPC IBM server, or alternatively, in machines executing other architectures. They can be emulated in the existing and in future IBM servers and on other machines of IBM (e.g., pSeries® Servers and xSeries® Servers). They can be executed in machines where generally execution is in an emulation mode.

In emulation mode, the specific instruction being emulated is decoded, and a subroutine is built to implement the individual instruction, as in a C subroutine or driver, or some other technique is used for providing a driver for the specific hardware, as is within the skill of those in the art after understanding the description of an embodiment of the invention.

Moreover, the various embodiments described above are just examples. There may be many variations to these embodiments without departing from the spirit of the present invention. For instance, although a logically partitioned environment may be described herein, this is only one example. Aspects of the invention are beneficial to many types of environments, including other environments that have a plurality of zones, and non-partitioned environments. Further, there may be no central processor complexes, but yet, multiple processors coupled together. Yet further, one or more aspects of the invention are applicable to single processor environments.

Although particular environments are described herein, again, many variations to these environments can be implemented without departing from the spirit of the present invention. For example, if the environment is logically partitioned, then more or fewer logical partitions may be included in the environment. Further, there may be multiple central processing complexes coupled together. These are only some of the variations that can be made without departing from the spirit of the present invention. Additionally, other variations are possible. For example, although the controller described herein serializes the instruction so that one IDTE instruction executes at one time, in another embodiment, multiple instructions may execute at one time. Further, the environment may include multiple controllers. Yet further, multiple quiesce requests (from one or more controllers) may be concurrently outstanding in the system. Additional variations are also possible.

As used herein, the term “processing unit” includes pageable entities, such as guests; processors; emulators; and/or other similar components. Moreover, the term “by a processing unit” includes on behalf of a processing unit. The term “buffer” includes an area of storage, as well as different types of data structures, including, but not limited to, arrays; and the term “table” can include other than table type data structures. Further, the instruction can include other than registers to designate information. Moreover, a page, a segment and/or a region can be of sizes different than those described herein.

One or more of the capabilities of the present invention can be implemented in software, firmware, hardware, or some combination thereof. Further, one or more of the capabilities can be emulated.

One or more aspects of the present invention can be included in an article of manufacture (e.g., one or more computer program products) having, for instance, computer usable media. The media has embodied therein, for instance, computer readable program code means or logic (e.g., instructions, code, commands, etc.) to provide and facilitate the capabilities of the present invention. The article of manufacture can be included as a part of a computer system or sold separately. The media (also known as a tangible storage medium) may be implemented on a storage device 120 as fixed or portable media, in read-only-memory (ROM) 116, in random access memory (RAM) 114, or stored on a computer chip of a CPU (110), an I/O adapter 118 for example.

Additionally, at least one program storage device 120 comprising storage media, readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A computer program product for managing a multi-level register hierarchy, comprising a first level pool of registers for caching registers of a second level pool of registers, the computer program product comprising a tangible storage medium readable by a processing circuit and storing instructions for execution by the processing circuit for performing a method comprising:
assigning, by a processor, architected registers to available entries of one of said first level pool or said second level pool, wherein architected registers are defined by an instruction set architecture (ISA) and addressable by register field values of instructions of the ISA, wherein the assigning comprises associating each assigned architected register to a corresponding an entry of a pool of registers;
moving architected register values to said first level pool from said second level pool according to a first level pool replacement algorithm;
based on instructions being executed, accessing architected register values of the first level pool of registers corresponding to said architected registers;
based on executing a last-use instruction for using an architected register identified as a last-use architected register, un-assigning the last-use architected register from both the first level pool and the second level pool, wherein un-assigned entries are available for assigning to architected registers.

2. The computer program product according to claim 1, further comprising:
based on determining the last-use instruction is to be executed, the last-use instruction including a register field value identifying the last-use architected register to be un-assigned after execution of the last-use instruction, copying the value of the last-use architected register to a second level physical register of the second level pool of registers;
then, executing the last-use instruction; and
performing the un-assigning of the physical register after last-use of the value of the architected register according to the last-use instruction; and
then, un-assigning a physical register, of the second level pool of registers, as the architected register based on the last-use instruction being executed being committed to complete.

3. The computer program product according to claim 2, further comprising:
based on decoding the last-use instruction for execution, determining that the last-use architected register is to be un-assigned after execution of the last-use instruction.

4. The computer program product according to claim 2, wherein the un-assigning the physical register is determined by instruction completion logic of the processor.

5. The computer program product according to claim 4, wherein the multi-level register hierarchy holds recently accessed architected registers in the first level pool and infrequently accessed architected registers in the second level pool.

6. The computer program product according to claim 5, wherein the architected registers comprise any one of general registers or floating point registers, wherein architected instructions comprise opcode fields and register fields, the register fields configured to identify a register of the architected registers.

7. The computer program product according to claim 1, further comprising:
executing a last-use identifying instruction, the execution comprising identifying an architected register of the last-use instruction as the last-use architected register.

8. A computer system for managing a multi-level register hierarchy, the system comprising:
processor configured to provide a first level pool of registers for caching registers of a second level pool of registers, the processor configured to communicate with a main storage, the processor comprising an instruction fetcher, and one or more execution units for executing instructions, the processor configured to perform a method comprising:
assigning, by a processor, architected registers to available entries of one of said first level pool or said second level pool, wherein architected registers are defined by an instruction set architecture (ISA) and addressable by register field values of instructions of the ISA, wherein the assigning comprises associating each assigned architected register to a corresponding an entry of a pool of registers;
moving architected register values to said first level pool from said second level pool according to a first level pool replacement algorithm;
based on instructions being executed, accessing architected register values of the first level pool of registers corresponding to said architected registers;
based on executing a last-use instruction for using an architected register identified as a last-use architected register, un-assigning the last-use architected register from both the first level pool and the second level pool, wherein un-assigned entries are available for assigning to architected registers.

9. The system according to claim 8, further comprising:
based on determining the last-use instruction is to be executed, the last-use instruction including a register field value identifying the last-use architected register to be un-assigned after execution of the last-use instruction, copying the value of the last-use architected register to a second level physical register of the second level pool of registers;
then, executing the last-use instruction; and
performing the un-assigning of the physical register after last-use of the value of the architected register according to the last-use instruction; and
then, un-assigning a physical register, of the second level pool of registers, as the architected register based on the last-use instruction being executed being committed to complete.

10. The system according to claim 9, further comprising:
based on decoding the last-use instruction for execution, determining that the last-use architected register is to be un-assigned after execution of the last-use instruction.

11. The system according to claim 9, wherein the un-assigning the physical register is determined by instruction completion logic of the processor.

12. The system according to claim 11, wherein the multi-level register hierarchy holds recently accessed architected registers in the first level pool and infrequently accessed architected registers in the second level pool.

13. The system according to claim 12, wherein the architected registers comprise any one of general registers or floating point registers, wherein architected instructions comprise opcode fields and register fields, the register fields configured to identify a register of the architected registers.

14. The system product according to claim 8, further comprising:
executing a last-use identifying instruction, the execution comprising identifying an architected register of the last-use instruction as the last-use architected register.
